(19) United States
(12) Patent Application Publication
(10) Pub. No.: US 2009/0169171 A1
(43) Pub. Date: Jul. 2, 2009

(54) METHODS AND DEVICES FOR COORDINATING FUNCTIONS OF MULTIMEDIA DEVICES

(75) Inventors: NOEL S. MASSEY, CARPENTERSVILLE, IL (US); JOSEPH C. TULLIO, CHICAGO, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/965,096

(22) Filed: Dec. 27, 2007

(51) Int. Cl. H04N 5/76

(52) U.S. Cl. 386/68; 386/E05.001

(57) ABSTRACT

Disclosed are methods and devices that facilitate new interactive experiences for users of WiMAX, 4 G, or other media-sharing enabled devices. The methods and devices for delivering primary media content to a set of media systems are configured to coordinate at least one visual media system with other visual media systems to foster sharing of content. The method includes broadcasting a stream of primary media content to the set of visual media systems that are configured to control the stream of primary media content. At least one of the visual media systems can be configured to issue a command to pause the stream of media content. The method also includes generating a notification to be transmitted to the other visual media systems that a command to pause has been received. In this manner, synchronizing the pausing and resuming of playback of media content among the visual media systems can be achieved.

### FIELD

Disclosed are methods and devices for coordinating functions of a set of multimedia devices, and more particularly methods and devices for coordinating function of multimedia devices to support sharing a common media content among a set of devices.

### BACKGROUND

Mobile communication devices enjoy enormous popularity in many parts of the world. Manufacturers and service providers have responded to this popularity by adding new features and capabilities to the use of mobile communication devices so that the devices have evolved, and are continuing to evolve, into more than simply devices for voice communication by telephone. WiMAX and the development of 4 G networks will provide the capability for mobile communication devices to experience multimedia content. Moreover, multiple users may be able to share the same multimedia content on separate devices.

The ability to share the experience with others is a much desired capability. Sharing of multimedia content across multiple mobile communication devices brings about a new set of experiences and problems to face. One area of opportunity is the ability to experience content based on social input. Another area of opportunity is the capability to use the pause period to insert marketing, advertising, news, or other media streams. Sharing content brings benefit to both device users and content providers.

### BRIEF DESCRIPTION OF THE DRAWINGS

FIG. 1 shows according to an embodiment a visual media system, that may be for example a mobile communication device, configured to communicate with other similarly configured devices to synchronize pausing of a broadcast stream of primary media content and to synchronize resuming of the stream;

FIG. 2 shows according to an embodiment a set of devices that may be sharing media content and are configured to synchronize the pausing and the playback of the media on the set of devices;

FIG. 3 shows a signal flow diagram that may correspond to the operation of the devices of FIG. 2 for coordinating the sharing of media content; and

FIG. 4 shows a flow chart of an embodiment of a method for coordinating operation of a set of multimedia devices like those of FIG. 2, for sharing of media content.

### DETAILED DESCRIPTION

It is desirable therefore to share content, and to manage sharing of content, among several devices. During a shared media experience, such as when several people watch video on different devices in different locations, one or more users may wish to pause the media playback. Additionally, if users are sharing an experience with multiple audio/video streams, such as in Social TV where users can talk to other users while video is being played, there may be a need to pause one of these streams. For example, the video stream may be paused while allowing the other streams which may include audio conversations, to continue.

It would be beneficial were a user of a visual media system able to coordinate the visual media system with other visual media systems to foster sharing of content by, for example, synchronizing the pausing and resuming of playback of media content among the visual media systems. Specifically, in order to maintain a shared experience the playback of the media on the other devices of group members could also be paused. It would also be beneficial if the visual media systems were configured to alert users when pausing of media content is about to take place, and when resumption of playback of media content is about to take place. It would further be beneficial if, during a period when visual media content is paused, for example, by one user, the visual media devices were configured to provide an additional window or other user interface option in order that other content may be viewed during the pause period, or in order that an application may be executed during the pause period.

As described below, presently-disclosed and other embodiments may facilitate new interactive experiences for users of WiMAX, 4 G, or other media-sharing enabled devices. Disclosed are methods and devices for delivering primary media content to a set of visual media systems, configured to coordinate at least one visual media system with other visual media systems to foster sharing of content. A method may include, for example, broadcasting a stream of primary media content to the set of visual media systems that are configured to control the stream of primary media content. At least one of the visual media systems can be configured to issue a command to pause the stream of media content. The method also includes generating a notification to be transmitted to the other visual media systems that a command to pause has been received. In this manner, synchronizing the pausing and resuming of playback of media content among the visual media systems can be achieved.

Disclosed in addition are methods and devices that may transmit alert signals to visual media systems that pausing of the broadcasting of primary media content is about to take place, and also when resumption of playback of media content will occur. For example, users may be notified at the beginning of a pause period, that the pausing is for a predetermined period of time, for example, 30 seconds. In another embodiment, users may be notified that the pause period is coming to an end, and that the visual media systems will be resuming receiving a broadcast of primary media content. In addition, the visual media systems may be configured to issue an alert, such as an audio alert, visual alert, a vibration alert, and/or a scent alert, that the pause period is coming to an end. In this manner, users may be alerted when pausing of media content is about to take place, and when resumption of playback of media content is about to take place.

Disclosed as well are methods and devices whereby visual media devices are configured to provide an additional window or other user interface option when broadcasting of primary media content to a plurality of visual media systems is paused, for example, by a user of one of the visual media systems. The additional window or other user interface option may be provided in order that independent or additional activity of the other visual media devices may take place. In an embodiment the additional window may be, for instance, inset into the display screen of the visual media system, in order that other content may be viewed during the pause period. In this way the visual media devices may provide for social interaction, entertainment, or other activities during the pause period.

The disclosed methods and devices enable the sharing of content, and to management of the sharing of content, among several devices. The shared experience is fostered through synchronization of the pausing and the playback of the media on the other devices of members of a group sharing the same primary media content. Moreover, the methods and devices described below need not be limited to mobile communication devices, but can also be embodied in television systems, home entertainment centers, computers, portable multimedia devices, and other devices with multimedia capability.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

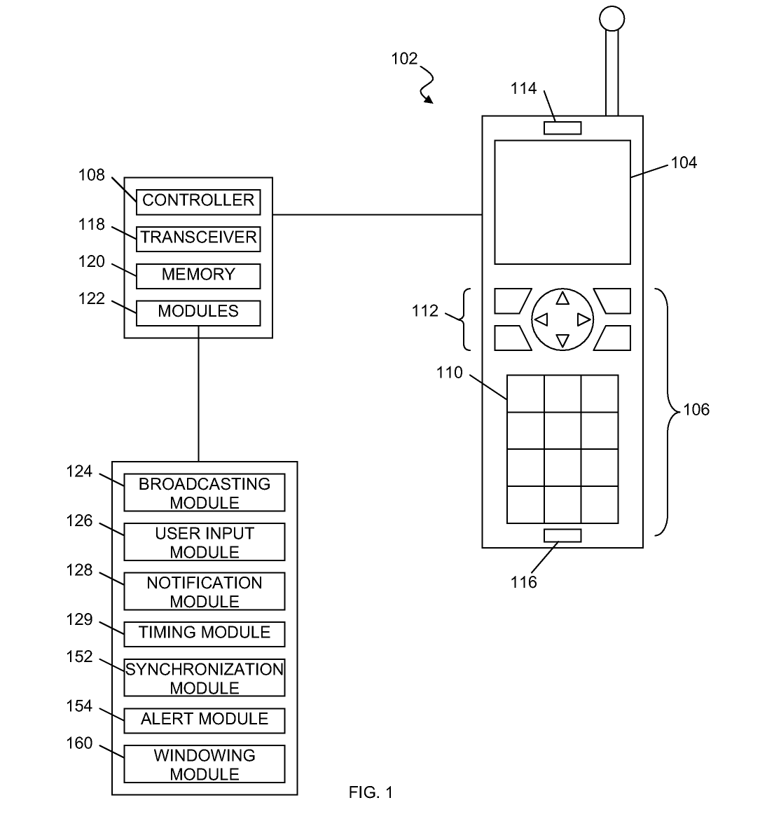

FIG. 1 shows according to an embodiment a visual media system 102, that may be for example a mobile communication device, configured to communicate with other similarly configured devices to synchronize pausing of a broadcast stream of primary media content and to synchronize resuming of the stream. For example, a user may input a command to pause the stream of media content. The device 102 may communicate with one or more other visual media systems that are also configured to synchronize pausing and resuming of media streaming. In this manner, the set of devices may coordinate multimedia playback. Accordingly, the device 102 may foster the sharing of a media experience through the synchronization of the pausing and the playback of the media on the other devices of members of a group sharing the same primary media content. In this way the visual media devices may provide for social interaction, entertainment, or other activities during the pause period. It is understood that the devices and methods described in this disclosure need not be limited to mobile communication devices.

The mobile communication device 102 may be implemented as a cellular telephone (also called a mobile phone). The mobile communication device 102 represents a wide variety of devices that have been developed for use within various communication networks. Such handheld communication devices include, for example, cellular telephones, messaging devices, personal digital assistants (PDAs), notebook or laptop computers, mobile data terminals, application specific gaming devices, video gaming devices, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The mobile communication device 102 is shown with a display 104 and a user input device 106 coupled to a controller 108. The user input device may include a keypad 110, as well as a set 112 of function keys or soft keys that may include a navigation circle. Other user interface components include an earpiece or speaker 114 and a microphone 116.

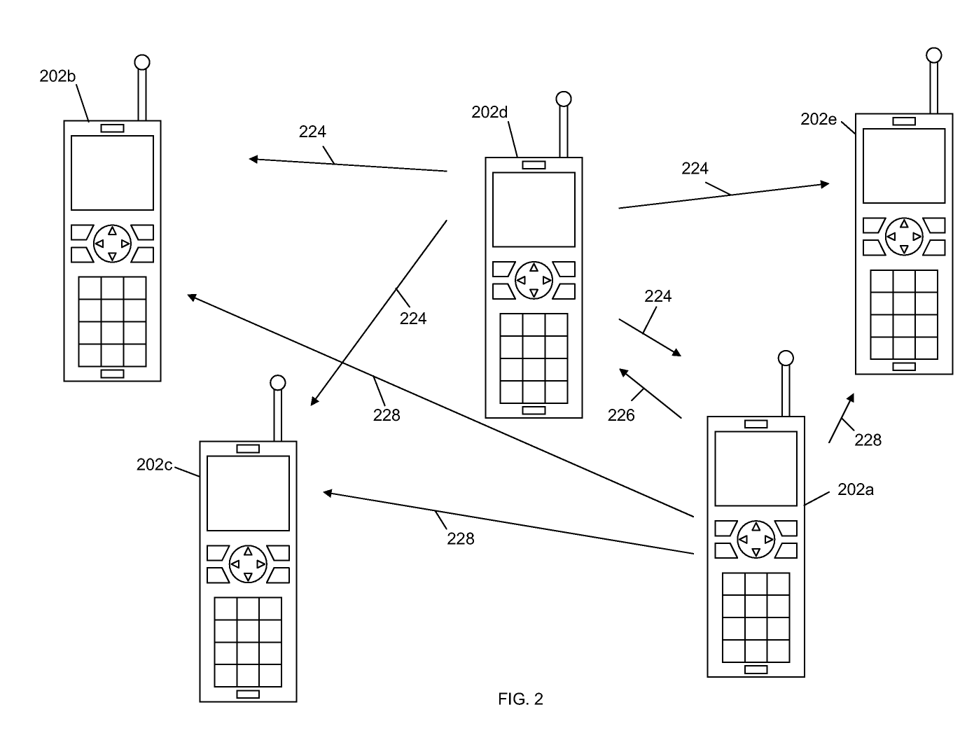

As discussed above, the device 102 may receive or deliver a stream of broadcast primary media content. The device 102 may be one of a set of devices (see FIG. 2) that may be utilized by several users to watch, for example, video on the different devices, perhaps in different locations. There may arise a situation where one of the users may wish to pause the media playback. In order to maintain a shared media experience, the playback of video on the other devices may also be paused. A notification signal may be provided to the other devices that the primary media content is paused. In this way, social interaction may be fostered, since users may talk, enjoy other content, or engage in other activities while the primary media content is paused, particularly if the media content is to be paused for a predetermined period of time.

Streaming media may be received or delivered via a transceiver 118 coupled to the controller 108. The device in addition may include a memory 120 coupled to the controller 108, and modules 122. The modules 122 include instructions to carry out steps of the methods described below. Moreover, it is understood that some modules 122 may be implemented in hardware, or include hardware components.

The modules 122 include a broadcasting module 124, a user input module 126, a notification module 128, a timing module 129, a synchronization module 152, an alert module 154, and a windowing module 160. It is understood that the mobile communication device 102 may include additional modules that may augment its multimedia functionality, for example by enabling operation of a digital still or video camera.

The modules 122 can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The methods, processes, and operations in accordance with the modules are discussed in more detail below, in connection with FIGS. 2, 3, and 4.

FIG. 2 shows according to an embodiment a set of devices 202a, 202b, 202c, 202d, and 202e that may be sharing media content and are configured to synchronize the pausing and the playback of the media on the set of devices. As shown, devices 202a, 202b, 202c, and 202e are receiving a stream of primary media content. It is understood that a device 102 (see FIG. 1) may be configured to act as a server to broadcast primary media content. For example, device 202d functions in the role of server by broadcasting 224 content to the other devices 202a, 202b, 202c, and 202e. The broadcasting may take place in accordance with instructions of the broadcasting module 124. In another embodiment, a separate server, for example a network server that may provide content for Social TV, may provide the primary media content. It is understood that primary media content may be provisioned to the devices in any manner without departing from the scope of this disclosure.

While the primary media content is being provisioned to the devices 202a, 202b, 202c, and 202d, it may happen that a user for example, associated with the device 202a, may wish to pause the stream of primary media content. For example, the user may wish to pursue a discussion of a particular topic related to the streamed media content. As another example, the user may desire to pause the stream of content in order to engage in a short telephone call or other communication. In any event, the user may enter a pause command to the device 202a via, for example, a soft key or other input function 112 (see FIG. 1) of a user input device 106 of the device 202a, in accordance with instructions of the user input module 126. The device 202a may then transmit a pause signal 226 to the server 202e to pause the stream of primary media content.

The device 202a may in addition send notification signals 228 to the other media devices 202b, 202c, and 202e. The notification signals 228 may include notification that a pause command has been issued. The notification signals may be generated and transmitted in accordance with the notification module 128 (see FIG. 1). Moreover, as a result of the notification signals 228, the devices 202b, 202c, and 202e may also issue pause commands to coordinate and synchronize pausing with that of the device 202a. The synchronization among the devices 202a, 202b, 202c, and 202e may occur in accordance with instructions of the synchronization module 152. In another embodiment, the pausing of the stream of media content to devices 202b, 202c, and 202e may result from the pause signal 226, and not from pause commands issued by the devices 202b, 202c, and 202e to the server device 202d. In this latter embodiment or in still another embodiment, notification that a pause command has been issued may be sent to the devices 202b, 202c, and 202e by the device 202d.

The notification signals 228 may include an indication that the pause command was issued by the device 202a. The notification signals 228 may also include information as to the length of the pause. For example, the server 202d and/or the device 202a may be configured so that the duration of pausing of the stream of primary media content can be selected from a set of time period durations, for example, 15 seconds, 30 seconds, 1 minute, or even for a few hours, in accordance with instructions of the timing module 129 (see FIG. 1). It is also possible that the pause command is for an indeterminate period of time, and the notification signals 228 may include an indication that the length of the pause period will be indeterminate.

As discussed above, the user of device 202a may wish to pause the stream of broadcast primary media content. Additionally if the user indicates for example that the pause will last for three minutes the system or device 202d may prevent the media from being resumed before three minutes has elapsed. In this way, other users in the shared media experience may better plan what to do during the paused time, and the other users will not be surprised by another user resuming the media playback earlier than expected. Alternatively, after the media is paused each client or user could indicate when they were ready to continue and the system would resume when all parties have indicated that they are ready to resume.

At the end of the pause period, the user of device 202a may coordinate resuming of the video or other media stream, in accordance with the synchronization module 152. In another embodiment, it may be a device of a different user that may coordinate the resuming of the stream. The resuming of the streaming of primary media content, whether initiated by the device 202a, or automatically by the device 202d upon the end of a pause period of predetermined length, or initiated by another device, may be accompanied by a notification that broadcasting of the stream of primary media content is about to resume.

The media devices 202a, 202b, 202c, 202d, and 202e may be configured to respond to a notification signal, such as pause notification signals 228, or other notification signals, with an alert. An alert may be useful because when a shared media experience is paused, users may set down the media device 102 (see FIG. 1) or move into a separate room away from the media device. Therefore the user may not be aware when the shared media experience resumes after being paused. By making an explicit sound, flash, vibration, or other sensory effect the user could be informed of this state change. The alert can enable smoother transitions and allow users to multitask without losing the effect of experiencing shared media.

The alert may be an audio alert, such as a beeping or other sound, or may be visual, vibratory, or a scent alert. A visual alert may for example include flashing of lights or a display screen. A vibratory alert may be useful if a visual media system or device 102 (see FIG. 1) may be worn or place in a user's pocket during a pause period. A scent alert may be useful in other contexts. The alert may be issued according to instructions of the alert module 154. It this way the visual media systems can alert users when pausing of media content is about to take place, and when resumption of playback of media content is about to take place.

When a shared media experience is paused users may choose to start an additional task including using an application that was not used during the shared experience. A device 202b for example may be configured to open an auxiliary window on the display 104 (see FIG. 1) in which the application may run. Opening of the auxiliary window may take place according to a windowing module 160. It is understood that another user interface option may be available in place of an auxiliary window on the display. For example, a user may wish to engage in a telephone conversation. When the shared experience is resumed the application, and the associated window, may be automatically suspended, minimized, or otherwise closed in order to assist the user in re-joining the shared media experience. In this manner, during a period when visual media content is paused, for example, by one user, the visual media devices can provide an additional window or other user interface option in order that other content may be viewed during the pause period, or in order that an application may be executed during the pause period.

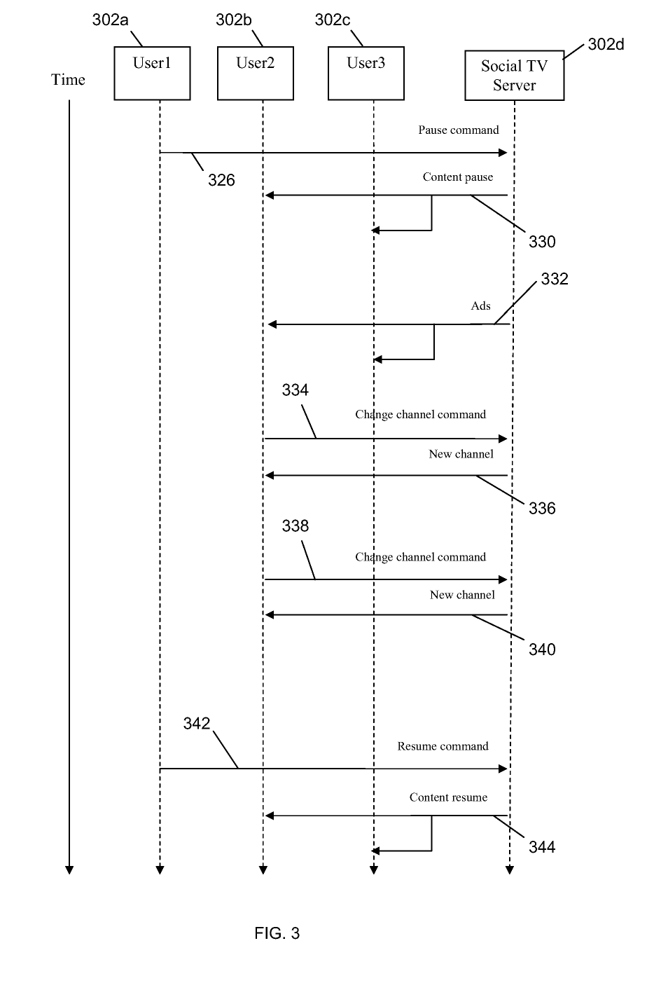

FIG. 3 shows a signal flow diagram that may correspond to the operation of the devices, such as those of FIG. 2, for coordinating the sharing of media content. The devices 302a, 302b, and 302c are initially receiving broadcast primary media content from the server 302d, in this example indicated as a Social TV server. A user of device 302a generates a pause command 326, and transmits the pause command to the server 302d. As discussed above, the pause command 326 may be accompanied by a notification of the pause, sent to the devices 302b and 302c. The server 302d pauses the content 330 to the devices 302b and 302c, as well as to device 302a. Upon pausing the primary media content, the server 302d may commence streaming a commercial or other advertising material 332 to the devices 302b and 302c.

The pausing of the primary media content provides opportunity to the users of device 302b and 302c to pursue other activities, such as viewing of advertising material. For example, the device 302b may send a command 334 to the server 302d to change to a different channel, for example, a different TV channel. The server may then commence streaming content 336 of the different channel to the device 302b. The device 302b may continue to stream media, for example, once again sending a command 338 to the server 302d to change to another channel. The server may respond to the command 338 by streaming different content 340 to the device 302b.

As just mentioned, during the pause a device, for example, device 302b may send a command 334 to the server 302d to change channels. The device 302b may instead connect to a different server during the pause of the server 302d. In another case the device 302b may instead connect to a different media stream from the server 302d, or may even display locally stored media content, for example, locally stored advertising material, that may be stored in the memory 120 (see FIG. 1). The above-recited examples show that during the pause period a server such as the server 302d may deliver ancillary media content, and a device, such as device 302b may display other media content while the primary media content is paused.

At the end of the pause period, the device 302a may send a command 342 to the server 302d to resume the broadcasting of the stream of primary media content. The server 302d can then recommence the streaming 344 of the primary content to the devices 302b and 302c. It is understood that the depiction of FIG. 3 is illustrative only, and that more or fewer media devices may be included in a shared media experience. It is also understood that another sequence of signals between visual media systems may act to coordinate the functions of the devices without departing from the scope of this discussion. It is further understood that additional activities, whether shared or solitary, may take place during one or more pause periods. In this manner, the users of visual media systems may coordinate their visual media systems with each others' so as to foster sharing of content by, for example, synchronizing the pausing and resuming of playback of media content among the visual media systems.

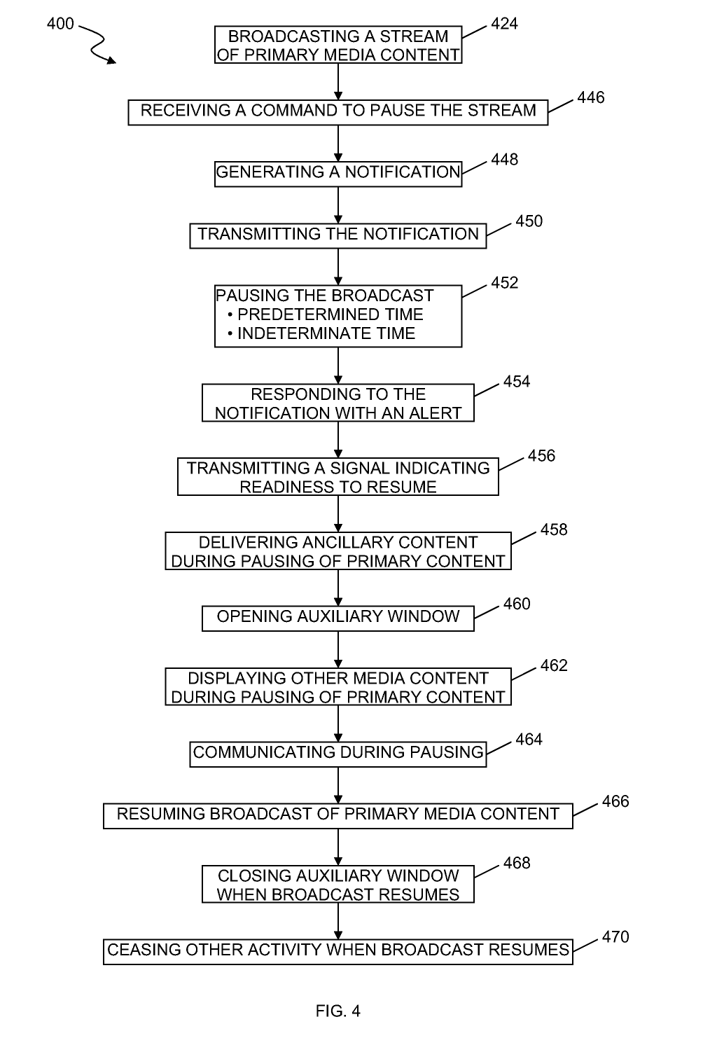

FIG. 4 shows a flow chart of an embodiment of a method 400 for coordinating operation of a set of multimedia devices like those of FIG. 2, for sharing of media content. A server, for example the device 202d (see FIG. 2) may provide media content by broadcasting 424 a stream of primary media content to a set of visual media systems that are configured to control the stream of media content. As previously discussed, the broadcasting of primary media content may occur according to instructions of the broadcasting module 124 (see FIG. 1). As discussed above, the set of visual media systems may be mobile communication devices configured with multimedia capability. The visual media systems may include other systems, as mentioned above, for example, in television systems, home entertainment centers, computers, portable multimedia devices, and other devices with multimedia capability.

The server 202d (see FIG. 2) or 302d (see FIG. 3) may receive 446 from one of the devices, for example, device 202a, a command to pause the stream of primary media content. Prior to pausing the streaming of media content, the server 202d may generate 448 a notification signal that a command to pause has been received, and then may transmit 450 the notification signal to at least one of the plurality of visual media systems 202b, 202c, and/or 202e, in accordance with the notification module 128 (see FIG. 1). The server also pauses 452 the broadcasting of the stream of primary media content. In another embodiment, the devices 303b and 303c may pause the stream of broadcast primary media content from the server 302d. The coordination and synchronization of the pausing and resuming (see below) of the broadcasting of the primary media content may take place according to the synchronization module 152.

The pausing of the broadcast may persist for a predetermined time, for example, as discussed above, 15 seconds or 30 seconds. The predetermined time intervals may correspond to lengths of commercials, for example, in a Social TV setting. The predetermined time intervals may also include lengths of 1 minute, several minutes, even lengths up to hours, in accordance with timing module 129 (see FIG. 1). The server 202d (see FIG. 2), or the device 202a issuing the pause command, may send a signal indicating to at least one of the plurality of visual media systems or devices the predetermined period of time for pausing.

Some pause periods may persist for indeterminate periods of time, for example in cases where a user who issues the pause command may not know in advance the time it may take to answer a phone call, discuss a point of interest that appeared in the stream if primary media content, or other activities.

One or more of the visual media systems 202b (see FIG. 2), 202c, and/or 202e may be configured to respond 454 to the notification signal with an alert, in accordance with the alert module 154. As discussed above, the alert may be selected from a group consisting of an audio alert, a visual alert, a vibration alert, and a scent alert. In addition, one or more of the visual media systems 202b (see FIG. 2), 202c, and/or 202e may be configured to transmit 456 a signal to the server 202b that it is prepared to resume receiving the broadcast of primary media content.

As discussed above, the devices may pursue other activities during a period in which broadcasting of primary media content is paused. For example, the server 303d (see FIG. 3) may provide advertising material 332, or may deliver 458 other ancillary content to the devices 303b and/or 303c, such as programming available on other channels 340. Moreover, a device, for example device 303b may open 460 an auxiliary window, in accordance with instructions of the windowing module 160 (see FIG. 1) for viewing of the ancillary content or for execution of an application during the pause period. The device 303b may display 462 other media content, for example the ancillary content 458 in the auxiliary window, or may display the other media content using the customary display area of the display 104 (see FIG. 1).

During the pause period, devices for example device 302b and 302c may communicate 464, for example, one with another. In an example, an audio channel may be available for sharing comments on the primary media content. When the broadcast of primary media content is paused, the audio channel may still be available for communication among the users participating in the shared media experience. Alternatively, users may communicate via for example, SMS messaging, email, or other communication media.

When the pause period is over, and the broadcast of primary media content resumes 466, devices that have opened auxiliary windows may close 468 them in order to resume sharing the primary media content. For example, displaying of other media content ceases 470, as do other activities, when primary media content broadcasting is resumed. The closing of the auxiliary windows may take place automatically when the broadcast resumes, or may take place after confirmation by a user.

Disclosed above are methods and devices that facilitate new interactive experiences for users of WiMAX, 4 G, or other media-sharing enabled devices. The disclosed methods and devices for delivering primary media content to a set of visual media systems are configured to coordinate at least one visual media system with other visual media systems to foster sharing of content. The method includes broadcasting a stream of primary media content to the set of visual media systems that are configured to control the stream of primary media content. At least one of the visual media systems can be configured to issue a command to pause the stream of media content. The method also includes generating a notification to be transmitted to the other visual media systems that a command to pause has been received. In this manner, synchronizing the pausing and resuming of playback of media content among the visual media systems can be achieved.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

What is claimed is:

1. A method for delivering primary media content to a plurality of visual media systems, the method comprising:
broadcasting a stream of primary media content to a plurality of visual media systems that are configured to control the stream of media content;
receiving from at least one of the plurality of visual media systems a command to pause the stream of primary media content;
generating a notification signal that a command to pause has been received;
transmitting the notification signal to at least one of the plurality of visual media systems; and
pausing the broadcasting of the stream of primary media content.

2. The method of claim 1, wherein a visual media system is configured to function as a server to broadcast the stream of primary media content, receive the command to pause the stream, generate the notification signal, transmit the notification signal, and pause the stream.

3. The method of claim 1, further comprising:
pausing for a predetermined period of time; and
indicating to at least one of the plurality of visual media systems the predetermined period of time for pausing.

4. The method of claim 1, wherein a visual media system is configured to respond to the notification signal with at least one alert selected from the group consisting of:
an audio alert, a visual alert, a vibration alert, and a scent alert.

5. The method of claim 1, further comprising:
at least one of the plurality of visual media systems transmitting a signal that it is prepared to resume receiving the broadcast of primary media content.

6. The method of claim 1, further comprising:
delivering ancillary media content during pausing.

7. The method of claim 1, further comprising:
opening an auxiliary window in at least one visual media system during pausing.

8. The method of claim 7, further comprising:
resuming broadcasting primary media content; and
closing the auxiliary window when primary media content broadcasting is resuming.

9. The method of claim 8, wherein closing the auxiliary window comprises closing the auxiliary window after user confirmation.

10. The method of claim 1, further comprising:
displaying by at least one of the visual media systems of other media content while the primary media content is paused.

11. The method of claim 10, further comprising:
resuming broadcasting primary media content; and
ceasing displaying by the at least one of the visual media systems of other media content when primary media content broadcasting is resumed.

12. A method of a system of visual media systems that are configured to communicate between each other and to receive primary media content, the method comprising:
receiving a broadcast of primary media content;
generating by at least one of the visual media systems, a pause command;
transmitting by the at least one of the visual media systems, the pause command to pause the broadcast of the primary media content; and
receiving by at least one of the visual media systems, a notification signal that the broadcast of the primary media content is pausing.

13. The method of claim 12, wherein:
receiving a broadcast of primary media content, comprises:
receiving a broadcast of primary media content from a second of the visual media systems operating as a primary media content server;
and wherein:
transmitting by the at least one of the visual media systems, the pause command to pause the broadcast of the primary media content, comprises:
transmitting by the at least one of the visual media systems, the pause command to the second visual media system operating as a primary media content server to pause the broadcast of the primary media content.

14. The method of claim 12, further comprising:
pausing receiving the primary media content for a predetermined period of time.

15. The method of claim 12, further comprising:
pausing receiving the primary media content for an indeterminate period of time.

16. The method of claim 12, further comprising:
communicating between a plurality of visual media system during pausing.

17. An electronic device comprising:
a controller;
a transceiver coupled to the controller and configured to receive a stream of broadcast primary media content;
a display coupled to the controller and configured to render the primary media content;
a user interface coupled to the controller and configured to receive input to pause and resume the stream of broadcast primary media content;
wherein:
the electronic device is configured to communicate with other similarly configured devices to synchronize pausing of the stream and to synchronize resuming of the stream.

18. The electronic device of claim 17, wherein the device is configured to notify a similarly configured device that the stream of broadcast primary media content is being paused for a period of time in accordance with a pause command.

19. The electronic device of claim 17, wherein:
the device is configured to receive a notification signal from a similarly configured device that a stream of broadcast primary media content is being paused;
the device is configured to respond to the notification signal with an alert selected from the group consisting of:
an audio alert, a visual alert, a vibration alert, and a scent alert.

20. The electronic device of claim 17, wherein the device is configured to receive ancillary media content during pausing of the stream of broadcast primary media content.
